(19) United States
(12) Patent Application Publication
(10) Pub. No.: US 2012/0240084 A1
(43) Pub. Date: Sep. 20, 2012

(54) Graphic User Interface for Interactions with Datasets and Databases and a Method to Manage Information Units

(76) Inventors: Michal Polubinski, Mississauga (CA); Victoria Polubinska, Mississauga (CA)

(21) Appl. No.: 13/217,141

(22) Filed: Aug. 24, 2011

Related U.S. Application Data
(60) Provisional application No. 61/376,366, filed on Aug. 24, 2010.

(51) Int. Cl. G06F 3/048

(52) U.S. Cl. 715/848; 715/764

(57) ABSTRACT

Methods for data visualisation, browsing, entry, modification, querying, processing, storage and transfer are described herein.

The methods facilitate the maintenance and processing of complex data sets within operating systems, server and client applications on smart phones, portable computers, workstations, servers, mainframes and other computing devices using intuitive and appealing (two-dimensional and three-dimensional) visualisations of data. The benefits of using the methods described herein include increased speed and simplicity of data entry, the real-time verification of data conflicts and the controlled persistence of status indicators enabling users and automata to locate and re-verify data sets or records which require or might require attention and maintenance.

### TECHNICAL FIELD

This invention can be applied in the following fields:

Computer operating systems;

Smart phone operating systems;

Applications;

Data processing, entry, modifications, browsing;

Databases, data warehousing;

Database query, modifications, drilling;

Portable electronic devices;

Smart phones;

Desktop computers;

Workstations;

Servers;

Mainframe computers;

Distributed databases and depositories.

### BACKGROUND ART

The processing of information units within and between datasets and databases is cumbersome and time-consuming. In a web-driven world, datasets and databases are larger than ever before—with “web scale” becoming the term of choice to describe the ultimate size of problems. More specifically the transfer, management of relationships and of integrity of various size (including “petabyte” size) datasets with speed are increasingly complex. Another problem is the search through and retrieval of single-located or distributed sets of data, such as handled by Hypertablei or BigTableii.

Solution to Problem

The problem can be solved with the assignment and management of unique identifiers to each IU (Information Unit) of information at the sub-file level, such as a record, a dataset, a text paragraph, a sound track, a video clip (sequence of frames), a cell/row/column/region/table in a worksheet or a workbook. The processes to manage information Units can be controlled by various input methods; some of them being touch screen input or brain-generated neural signals or automated through the use of processing units.

The invention simplifies and speeds up the data entry of datasets into various components of a database. This is accomplished by simplified browsing throughout a database by scrolling through indexed fields, determining the best record location (can be null, i.e. a new record) for inclusion of the data set, dragging and dropping a dataset into the best location and detection of resulting conflicts (if any) with the existing contents of a database. The latter sets a stage for conflict resolution thanks to the flagging of incompatible contents of field(s).

Advantageous Effects of Invention

The following major types of applications will benefit from the functionalities of Graphic User Interface for Interactions with Multivariable Datasets:

Integrated low-level Customer Relationship Management (CRM) software,

CRM systems (Microsoft Dynamics CRM, Maximizer, Microsoft Business Contact Manager, etc.),

Accounting software (QuickBooks, Simply Accounting, ACCPAC, etc.),

Project Management software (Microsoft Project, Primavera, Oracle, etc.),

Enterprise Resource Planning software (Microsoft Dynamics ERP suite, SAP, Oracle, etc.),

File Management Systems (Windows Explorer, Finder, etc.),other.

The advantageous effects of invention include but are not limited to:

Simple, one touch transfer of a UI or a set of UIs from one depository to another;

Broadcasting UIs across multiple platforms;

Dynamic deduplication and consolidation of UIs on specific terms: The invention prevents creation of multiple entries for similar or close (in the information theory paradigm) UIs;

Dynamic archivisation: Providing the fastest access to the most frequently used UIs, and downgrading the access to the less frequently referenced UIs;

Capability to maintain the structure of multi-dependent data sets within a database or when subject to processing such as transmission, broadcasting, deduplication, synchronization, archivisation;

This invention is available royalty-free to small business entities on terms governed by customized licenses.

### BRIEF DESCRIPTION OF DRAWINGS

FIG. 1 shows relationships in three-dimensional space

### DESCRIPTION OF EMBODIMENTS

Two major implementations of the invention belong to two major groups of applications: Call Information Management (CIM) i.e. the methods to process an incoming call information on mostly, but not limited to: smart telephone, data processing.

### Example 1

In the first implementation, when a call is received, the call initiates creation a graphical object on a display. The object shall be tested for the presence in the existing Contacts Database. If the complete record exists in the database, the record can be retrieved and predefined details shall be displayed on the screen or announced by voice. If the dataset or its parts do not have comparable records in the database, the object representing the acquired dataset from a telephone call data can be dragged to a proper location in a Contacts Database. This can be followed by the completion of the processed record within the Contacts Database to a desired level (of completeness). Following that, the visual representation of the record can be dragged and dropped to an appointments calendar, meeting calendar, tasks, notes, projects, a group of contacts, or any other database. As the result of dropping a record the new record (e.g. appointment) in the next database will have a link to the index of the previous database (contacts). In case having links to many contacts for the same event, the appointment is reclassified as a meeting with a corresponding one-to-many relationship.

### Example 2

In the second implementation, the invention can be employed in information processing of any database, relational or hierarchical, such as, but not limited to the following: operating system for embedded processor interface, control system, portable electronic device, portable computer, desktop computer, workstation, server, mainframe computer, customer relationship management system, electronic commerce, catalogue, enterprise resource planning system, bookkeeping, accounting, tax-processing, financial application, interactive website, maintenance and repair application, internet browser, etc.

In this case when an initial entry is received or entered, it is displayed as a graphical object on a screen. The object shall be tested for the presence in the existing primary database. The primary database is selected as the most relevant to the set of received or entered data. If the complete record exists in the database, the record can be retrieved and predefined details shall be displayed on the screen or announced by voice. If the dataset or its parts do not have comparable records in the database, the object representing the acquired dataset from a telephone call data can be dragged to a proper location in a contacts database. This can be followed by the completion of the processed record within the contacts database to a desired level (of completeness).

Following that, the visual representation of the record can be dragged and dropped to an appointments calendar, meeting calendar, tasks, notes, projects, a group of contacts, or any other database. As the result of dropping a record, the new record (e.g. appointment) in the next database will have a link to the index of the previous database (contacts). Subsequently, the calendar event can be completed by adding other values in other fields, such as the end time of an appointment, priority, location, category, etc.

In case of having links to many contacts for the same event, the appointment is reclassified as a meeting with a corresponding one-to-many relationship.

Following a similar procedure, any dataset can be dropped in any pre-mapped database.

### Example 3 (Multiple)

Examples include, but are not limited to merging one of the following:

Contact info with a single task, Contact info with a task of a project as a resource, Start date and time with a task, Customer contact info with an invoice, Customer contact info with a payment received, Asset info and optionally, Universal Product Code with an inventory record, Internet Protocol ID (IPv4 or IPv6), and/or Media Access Control (MAC) with any database or database record.

### Example 4

TABLE 1
Hierarchy and Relationships Table
Hierarchy And Relationships Table (HART)

| | | | | | | | |
|---|---|---|---|---|---|---|---|
| InternalIndex.MaximumValue | ii.Max | | | | | 12 | |
| InternalIndex.NumberOfBits | ii.b | | | | | 4 | |
| InternalIndex.TableSize | ii.Size | | | | | 20 | |
| InternalIndex.CoordinateIndex | ii.0 | ii.1 | ii.2 | ii.3 | ii.P.n | ii.P.1 | ii.P.2 |
| | 1 | 1 | 2 | 11 | 0 | | |
| | 2 | 7 | 2 | 0 | 0 | | |
| | 3 | 8 | 6 | 12 | 1 | 2 | |
| | 4 | 3 | 2 | 5 | 0 | | |
| | 5 | 5 | 1 | 0 | 0 | | |
| | 6 | 6 | 3 | 0 | 2 | 4 | 2 |
| ii.i.n | | 8 | 6 | 12 | | | |
| | | ii.1.n | ii.2.n | ii.3.n | | | |

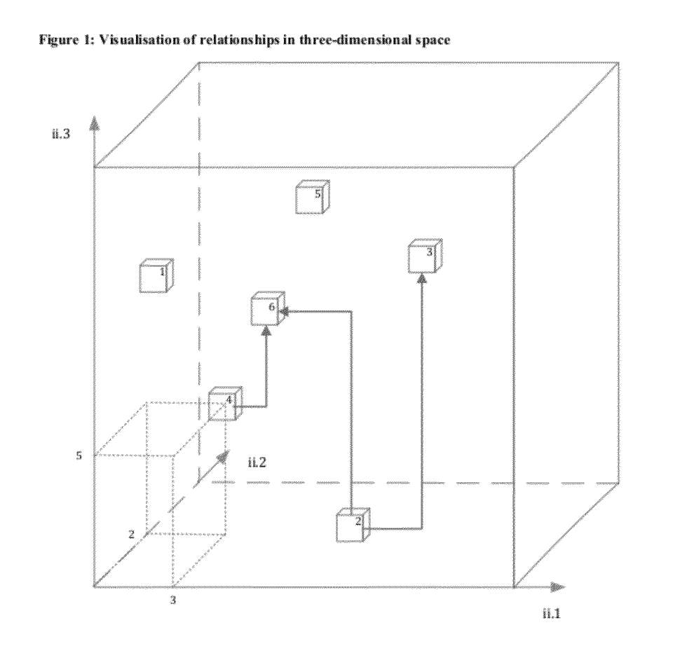

The elements listed in the Table 1 above are visualised in FIG. 1: Visualisation of relationships in three-dimensional space.

Patent Literature

### U.S. Patents:

U.S. Pat. No. 5,960,411 Method and system for placing a purchase order via a communications network

### 20100146067 Message Send Queue Reordering Based on Priority

2010235770 Methods and Graphical User Interfaces for Editing on a Multifunction Device with a Touch Screen Display
2010235778 Methods and Graphical User Interfaces for Editing on a Multifunction Device with a Touch Screen Display
2010235735 Methods and Graphical User Interfaces for Editing on a Multifunction Device with a Touch Screen Display
2010235734 Methods and Graphical User Interfaces for Editing on a Multifunction Device with a Touch Screen Display
2010235729 Methods and Graphical User Interfaces for Editing on a Multifunction Device with a Touch Screen Display
2010235726 Methods and Graphical User Interfaces for Editing on a Multifunction Device with a Touch Screen Display
2010235784 Methods and Graphical User Interfaces for Editing on a Multifunction Device with a Touch Screen Display
2010235783 Methods and Graphical User Interfaces for Editing on a Multifunction Device with a Touch Screen Display
2010235785 Methods and Graphical User Interfaces for Editing on a Multifunction Device with a Touch Screen Display

### 2010235780 System and Method for Identifying Words Based on a Sequence of Keyboard Events

20040236744 Method for ensuring referential integrity in highly concurrent database environments

### GLOSSARY OF TERMS

Objects

Graphical User Interface (GUI) Image rendered on a screen or projected on any non-translucent object, usually coupled with an Input Facility (IF). Examples of a projection on any non-translucent object including, but are not limited to: a side of a mountain, a side of a ship, a wall of a building, a smoke screen, a holographic projection, etc;

digiShape (dS) Object representing variables or fields, can be a two-dimensional object or an image of three-dimensional object, or a three-dimensional object;

digiCube (dC) Cubical object representing a single (one), tuplet (two), or triplet three) variables or fields;

digiTorus (dT) Toroidal object representing at least one variable or field;

Database (DB) Organized body of related information. DB can be hierarchical, relational or mixed, handled by a database engine, an explorer, a browser, or a spreadsheet application.

Properties

zOrder(zO) Position of an on-screen object relative to other objects. The zOrder can have the following values: in-front-of, in-front-of-all, behind-of, behind-of-all, hidden.

Events. All and any of events described below can be implemented with the use of any Input Facility (IF) as defined in the Combinations of Objects and Events Section below

Left click (L1) Single left mouse button or trackball button click

Right click (R1) Single right mouse button or trackball button click;

Left double click (L2) Double left mouse button or trackball button click;

Right double click (R2) Double right mouse button or trackball button click;

Single finger tap (FT1) Single finger tap on a touchpad, trackpad, mini-trackball, or touchscreen;

Double finger tap (FT2) Double finger tap on a touchpad, trackpad, mini-trackball, or touchscreen;

Single finger push (P1) Single finger push on a touchpad, trackpad, mini-trackball, or touchscreen;

Double finger push (P2) Double finger push on a touchpad, trackpad, mini-trackball, or touchscreen;

Release (RE) End of any of the above listed events by disengaging an as described below;

Slides/Swipes

Slide/Swipe (SE) Movement of a cursor on a screen caused by a corresponding slide of a finger(s) on the touch-screen or on a touchpad, a mouse slide, a rolling of a trackball, slide of a stylus on a tablet, a movement of a body part or an implement, etc. This could be accomplished with a single object or multiple objects, such as, but not limited to, single finger or two fingers, single mouse button, or two mouse buttons, etc.;

Horizontal slide/swipe (SH) Horizontal Slide/Swipe (SE) (slide or swipe);

Horizontal slide/swipe (SH1) Horizontal slide/swipe (SH) with a single object;

Horizontal slide/swipe (SH2) Horizontal slide/swipe (SH) with two objects;

Vertical slide/swipe (SV) Vertical Slide/Swipe (SE);

Vertical slide/swipe (SV1) Vertical slide/swipe (SV) with a single object;

Vertical slide/swipe (SV2) Vertical slide/swipe (SV) with two objects;

Expand (+) Outward Slide/Swipe (SE) with two objects, such as, but not limited to, moving two fingers or two arms apart;

Contract (−) Inward Slide/Swipe (SE) with two objects, such as, but not limited to, moving two fingers or two arms apart;

Circular slide/swipe (SC) Circular movement of a cursor on a screen caused by a corresponding slide of a finger(s) on the touch-screen or on a touchpad, a mouse slide, a spin of a trackball, a circular slide of a stylus on a tablet, a circular movement of a body part, or of an implement, etc;

Event Groups

Left Drag (DL) Movement of an object (continuous change of X and/or Y coordinates of the centre of an object) caused by Left click (L1), Slide/Swipe (SE) and Release (RE), usually including a click, slide and release events;

Right Drag (DR) Movement of an object (continuous change of X and/or Y coordinates of the centre of an object) caused by Right click (R1), Slide/Swipe (SE) and Release (RE), usually including a click, slide and release events;

Rotation (RN) Movement around Z axis (visualised as an axis pointing from a screen upward). Rotation (RN) can be accomplished by corresponding rotation of body parts or implements, such as but not limited to, rotation of a a ball of a trackball device. Another way of implementing Rotation (RN) is by Left Drag (DL) or Right Drag (DR) inducing a circular movement of a coupled object around Z axis.

Spin (SN) Movement around X (visualised as a horizontal axis) or Y axis (visualised as a vertical axis). Rotation (RN) can be accomplished by corresponding rotation of body parts or implements, such as but not limited to, a ball of a trackball device. Another way of implementing Rotation (RN) is by Left Drag (DL) or Right Drag (DR) inducing a circular movement of a coupled object around X or Y axis.

FIG. 1 Description

The Information Units shown in FIG. 1 have index values (ii.0) ranging from 1 to 6, each IU is positioned on axes ii.1, ii.2, ii.3. For example, IU(ii.0=3)=IU(3) is positioned at coordinates (ii.1, ii.2, ii.3)= (8, 6,12). IU(1), IU(2), do not have parents. Information Unit's (3) parent is IU(2), Information Unit's parents are IU(4) and IU(2). The set of six information units occupies cube of dimensions 8, 6,12. The Hierarchy and Relationships Table (HART) size is 20, equals the number of nonempty cells of the table. The maximum value of any cell is 12, and can be expressed with 4 bits.

### Non Patent Literature

Data Roket: http://www.dataroket.com/dr-at-a-glance/what-is-dataroket Lera Boroditsky: Taste, Smell, and Touch: Lecture Notes: http://www-psych.stanford.edu/˜lera/psyc115s/notes/lecture11/
Microformats: http://microformats.org/about Maemo 5 user interface: http://www.youtube.com/watch?v=Au_uRmoy8Fs&feature=related
Code Bubbles: Rethinking the User Interface Paradigm of Integrated Development
Environments: http://www.youtube.com/watch?v=PsPX0nEU0k i Hypertable; http://hypertable.org/ ii BigTable; http://en.wikipedia.org/wiki/BigTable

1. A Graphical User Interface Object (GUIO) coupled and/or interacting with an input Facility (IF) being a combination of and interaction of a user with mouse, a trackball, a mini-trackball, a trackpad, a touchpad, a touchscreen, a finger, a tablet, a stylus, a sound (voice, etc.) command, a body gesture, a grimace, a video camera, a laser scanner (such as but not limited to a LIDAR), a microphone, a pressure sensor, a spectrometer, an electrode, an antenna, etc; expression “such as’used throughout this document means “such as the following examples but not limited to” or “such as but not limited to ”).

2. A component of claim 1, embodied as a shape of any size, may be referred to as a digiShape (dS)

3. A component of claim 2, in a shape of a cube, a modified cube or any prism referred to as a digiCube (dC).

4. a component of claim 2, in a shape of a toroid (doughnut-shaped object) referred to as a digiTorus (dT).

5. A component of claims 2, 3 and 4, having its state represented by (formatted characteristic, such as: fill colour, outline colour, background colour, shadow colour, colour of reflection, texture, opacity, layer, z-order, zoom level, selected area zoom level, deformation, perspective, blend, pixelation, on-screen behavior, sound, and any other effect, behavior or property.

6. A component of claims 2, 3, 4 and 5 representing a database form.

7. A component of claim 2, 3, 4 and 5 representing a a database query.

8. A component of claim 1, serving as an Input Facility (IF).

9. A component of claim 8, embodied as a computer mouse.

10. A component of claim 8, embodied as a trackball.

11. A component of claim 9, embodied as a stylus interacting with a touchscreen, or with a touchpad, or with a tablet.

12. A component of claim 8, embodied as a finger or as fingers interacting with a touchscreen, or with a touchpad, or with a tablet.

13. A component of claim 9, comprising a specific sound or a voice command coupled with sound input and processing hardware and suitable software to convert specific sounds to digitized data.

14. A method of claim 8, involving an Input Facility (IF) coupled with suitable software to convert specific events to digitized data.

15. A method of claim 1, coupling events generated by any component of claims 9 to 15 to facilitate interactions with objects of claims 2 to 8.

16. A method of claim 15, to facilitate browsing through data and/or data sets.

17. A method of claim 17, to facilitate browsing using an at-focus single variable or a single field (simple scroll) activated by any of Slide/Swipe (SE) events.

18. A method of claim 17, to facilitate browsing by using any specific event or user-selected event with a specific set of parameters to scroll through a list of values of the single variable or a data field

19. A method of claim 17, to facilitate browsing by using an event classified as Vertical slide/swipe (SV) to scroll through a list of values of the single variable or a data field.

20. A method of claim 17, to facilitate browsing by using a magnifying lens effect to improve the readability of text or view by enlarging the said view of at-focus data. The effect may be implemented with or without delay during scrolling.

21. A method of claim 16, to facilitate browsing when another variable (change of in-focus variable) or data field needs to be reviewed.

22. A method of claim 21, to facilitate browsing by using any specific event or user-selected event with a specific set of parameters to scroll through a list of variables or data fields

23. A method of claim 21, to facilitate browsing by using an event classified as Horizontal slide/swipe (SH), or Rotation (RN), or Spin (SN) to scroll through a list variables or a data fields.

24. A method of claim 21, to facilitate browsing by using a magnifying lens effect to improve the readability of text or view by enlarging the said view of at-focus data. The effect may be implemented with or without delay during scrolling.

25. A method of claim 16, to facilitate browsing by moving down (drilling down) the database hierarchy level.

26. A method of claim 25, to facilitate browsing by using any specific event or user-selected event with a specific set of parameters to move down through a list of levels in the hierarchical or hybrid database.

27. A method of claim 25, to facilitate browsing by using an event classified as P or Left double click (L2) to move down through a list of levels in the hierarchical or hybrid database.

28. A method of claim 25, to facilitate browsing by using a magnifying lens effect to improve the readability of text or view by enlarging the said view of at-focus data. The effect may be implemented with or without delay during scrolling.

29. A method of claim 16, to facilitate browsing by moving up the database hierarchy level.

30. A method of claim 29, to facilitate, browsing by using any specific event or user-selected event with a specific set of parameters to move up through a list of levels in the hierarchical or hybrid database.

31. A method of claim 29, to facilitate browsing by using an event classified ass Double finger push (P2) or Right double click (P2) to move up through a list of levels in the heirachical or hybrid database.

32. A method of claim 29, to facilitate browsing by using a magnifying lens effect to improve the readability of text or view by enlarging the said view of at-focus data. The effect may be implemented with or without delay during scrolling.

33. A method of claim 15, to facilitate data entry. The data entry may require a focus of on a specific target database dataset or a group of datasets, or a subset of the database.

34. A method of claim 33, wherein an object representing a dataset is connected to a target database and the dataset's index is placed in an appropriate field.

35. A method of claim 33, wherein an object representing a dataset is dragged or visually linked to a target database.

36. A method of claim 33, wherein an object representing a incoming caller databaset is dragged or visually linked to a target database.

37. A method of claim 15, to display data conflict and to facilitate data conflict resolution.

38. A method of claim 37 to detect and flag one of the following level of data conflicts: Green or any suitable characteristic of claim 5 when no conflict is delete, orange or any suitable characteristic of claim 6 when new information is added to an existing dataset, red or any suitable characteristic of claim 6 when a conflict is detected.

39. A method of claim 37 to emphasize various conflict levels by utilizing additional behaviours, such as, but not limited to: steady light effect or any suitable characteristic of claim 6 when no conflict is detected, pulsating light effect or any suitable characteristic of claim 6 when new information is added to an existing dataset, flashing light effect or any suitable characteristic of claim 6 when a conflict is detected

40. A method of claim 37 to emphasize various conflict levels by utilizing additional behaviours, such as, but not limited to:
Carillon bell sound effect with gentle vibration or any suitable characteristic of claim 6 when no conflict is detected
Pulsating light effect with sinusoidal wave-modulated vibration or any suitable characteristic of claim 5 when new information is added to an existing dataset
Hissing sound effect with obnoxiously pulsating vibration or any suitable characteristic of claim 5 when a conflict is detected

41. A method of claim 15, to implement persistent sensory tagging (flagging) of a dataset.

42. A method of claim 41, to implement persistent color tagging of a dataset, such method enabling a user to review datasets which require attention.

43. A method of claim 41, to implement persistent color tagging of a recently entered dataset, enabling a user to review recently entered datasets which may require attention such as: recent caller datasets entered into calendar and/or lists of contacts tagged with a background color.

44. A method of claim 41, to implement the phasing-out of persistent sensory tagging of a dataset removing expired persistent tagging from datasets such as represented by green-tagged recent entries deactivating tagged properties after a selected number of hours of elapsed time.

45. An item (Header) comprising a set of parameters and/or properties such, but not limited to, internal index (ii), the first write date and time stamp, first write credentials, the last write date and time stamp, the last write credentials, the last read date and time stamp, the last read credentials, the delete date and time stamp, the delete credentials, the owner established date and time stamp, the owner credentials, publish level and domain array, hash value, pointer to a location in a storage device not identified by IP address, or storage unit address (including but not limited to), directory identifier, cluster identifier, file identifier, chapter or worksheet or clip or section or paragraph or row or column identifier, payload field size, cyclic redundancy check (CRC) or other means to accomplish the integrity of a related Information Unit (IU), other required related information, padding (if required), attached in any order: at the beginning, or at the end of the IU, or bound but unattached to the IU; wherein the Information Unit (IU) is a collection of Information Elements (a smallest indivisible content of information message, being a similar concept to an elementary particle in nuclear physics) of undefined size, (the IU can be featured on a display (1, 2, 3 or multi-dimensional), presented as a holograph, sounded (as a sound track), featured as taste, smell, or touch (Boroditskv, 1999), projected into brain, or presented, transmitted or stored as a state of modifiable matter (on surface of or within a volume of vacuum, gas, liquid, plasma, magnetic, optical, solid, etc. media).

46. The item (Hierarchy And Relationships Table (HART)) related to item of claim 45, comprising such items as its own identifier and fields such as Internal Index, location of the item of claim 445 on any coordinate axes, an identifier of a parent, etc.

47. The item (External REIationships Table (EXRET)) of a similar structure as item in claim 46 related to item of claim 45, comprising external addresses (such as defined by IPv6 protocol) bound to an externally referenced record.

48. The optional item containing all components claimed in items 46 and 47.

49. The optional item (pynamic Address Allocation Log (DAAL)) comprising its own identifiers, and the revolving FIFO register of past connections comprising such fields as an index of a source Information Unit, an index of a destination (target) Information Unit, IPv6 or similar address of a destination (target) Information Unit.

50. The processes related to item of claim 45, such as but not limited to: insert, modify, append, read, publish, delete, copy, move, etc.

51. The services related to item of claim 45, such as periodic refresh of metadata and tables, search for corrupted relations, etc. to ensure that recurring tasks are accomplished.

52. The protocols related to item of claim 45 to accomplish the integrity of the data and metadata, services to manage the data and metadata.

53. The item (registry) related to item of claim 45, comprising information required to, initialize, maintain and run the invented system, such as properties of related databases, tables, processes, services, protocols, etc.

54. The temporary binding of item of claim 45 to TCP protocol components, processed and services.

55. The temporary binding of item of claim 45 to IP protocol components, processes and services.
